(19) United States
(12) Patent Application Publication
(10) Pub. No.: US 2009/0022853 A1
(43) Pub. Date: Jan. 22, 2009

(54) Beverage

(75) Inventors: Hilda Batsheva Ten Brink, New York City, NY (US); Nicole Dawn Becker, Princeton, NJ (US); Christopher Allen Wilson, Ridgefield Park, NJ (US)

Correspondence Address: UNILEVER PATENT GROUP, 800 SYLVAN AVENUE, AG West S. Wing, ENGLEWOOD CLIFFS, NJ, 07632-3100, US

(73) Assignee: Conopco, Inc., d/b/a Unilever

(21) Appl. No.: 11/879,101

(22) Filed: Jul. 16, 2007

(51) Int. Cl. A23L 2/38

(52) U.S. Cl. 426/72; 426/74

(57) ABSTRACT

A food product, preferably a beverage, suitable for ingestion by humans and having at least 300 mg of potassium ion per 100 g serving, the potassium being from both one or more inorganic sources and one or more organic sources. The food product preferably has no fewer than 25 kcals and has fewer than 75 kcal per 100 g serving. By combining the high potassium levels with minimal calories, the food of the invention permits enjoyment of the benefits of high potassium in a food without the negative of high caloric intake.

### BACKGROUND OF THE INVENTION

Two medical conditions which have recently received much attention are overweight, particularly obesity, and hypertension. Excessive weight is frequently cited in reports of a recent increase in cases of type 2 diabetes. Moreover, obesity is often mentioned in discussions of other modern diseases, such as heart disease. Hypertension has long been considered an important risk factor in cardiovascular problems such as heart attack and stroke and is believed to be influenced by factors such as obesity and sodium intake.

There are numerous pharmaceuticals available to ameliorate hypertension. Included among these are drugs falling into the classes of ACE inhibitors, beta blockers and diuretics. Unfortunately, some of these drugs have undesirable side effects. For example, beta blockers are known in some instances to promote fatigue, and diuretics can cause mineral imbalances. Many consumers prefer to avoid pharmaceutical solutions where possible both to prevent side effects and to minimize the possibility of drug interactions.

A number of non-pharmaceutical agents have been proposed to minimize the risk of hypertension. These include coenzyme Q-10, minerals such as magnesium or potassium, herbs such as hawthorn, and amino acids such as taurine and arginine.

Potassium is a well known component of fruit juices. As refreshing beverages, fruit juices might be considered to be a desirable medium for ingestion of potassium and other healthful ingredients. However, some health professionals have been reluctant to embrace fruit juices as a healthful food since they tend to contain copious amounts of sugar and a considerable number of calories. Potassium at high levels of supplementation is known to cause a bitter taste. This has discouraged supplementation with high levels of potassium salts from inorganic sources and in some cases has required the addition of calories in the form of sugars to mask the taste. Therefore, it is would be desirable to develop a beverage or other food which includes a substantial amount of potassium yet does not include the caloric load of a typical fruit juice or sweetened supplement or the bitter taste of supplementation with high levels of potassium salts.

Morris et al. U.S. Pat. Nos. 5,804,204 and 5,498,428 are directed to a method for amerliorating or preventing hypertension in humans afflicted with or predisposed to hypertension comprising administering a therapeutically- or prophylactically-effective amount of a potassium salt wherein the anion is not a chloride or other halide. The salt may be potassium bicarbonate, potassium phosphate, or an alkalinizing potassium salt of a carboxylic acid, eg potassium gluconate, and potassium citrate. An effective dose of potassium bicarbonate is said typically to be 50-250 mmoles per 70 kg body weight per day. A number of different possible forms are mentioned for the compositions, such as tablets, capsules, powders, liquids, suspensions or the like. Indiscriminate use of potassium salts is said to produce toxic manifestations such as hyperkalemia and gastrointestinal irritation. Carriers for liquid compositions include water, aqueous dextrose, glucose, sucrose, magnesium carbonate and the like.

Masuyama U.S. Pat. No. 6,596,301 (Danone) is directed to an anti-stress agent and functional food containing same. The anti-stress agent is prepared by adding the agent to yoghurt, milk-containing acidified beverages, cheese, various processed foods, healthy foods, powdered foods, or granulated foods. The food may contain minerals. The anti-stress agent contains at least one fermented, sour milk.

Fields et al. US Patent Application Publication No. US 2003/0211204 is directed to a method for preparing mineral fortified beverages and beverage concentrates. In the background, potassium for blood pressure maintenance is mentioned. The nutritionally supplemented amount will generally comprise more than 5% of the Recommended Daily Allowance (RDA), preferably between 10% and 100% RDA. Fields provides as RDA for potassium 1900 to 5600 mg. Fields et al.'s invention encompasses single strength fruit juice beverages substantially free of added protein and including 0.002 to 0.26% by weight solubilized mineral, depending on the salt and type. Mineral supplemented fruit juice concentrates comprise between approximately 0.005 and 1.30% by weight solubilized mineral. Beverage products can be comprised of a fruit juice having 0.1% solubilized potassium. Other potassium supplemented beverages are mentioned. For fruit juice beverages, it is said that the nutritional content can range from 5% to 40% of RDI and for fruit juice concentrates from 20% to 60%. In Example 9, a ready to drink nutritionally fortified meal replacer includes 10.4 potassium hydroxide per liter and 1750 mg of potassium for 8 oz serving. Example 12 is a low calorie potassium fortified berry fruit flavored drink having 2.37 grams potassium hydroxide of a total of 130.68 grams product.

Draaisma et al. WO 2004/060073 is directed to a fermented milk product comprising VPP and/or IPP tripeptides and comprising 40-600 mmol/kg K+ and/or 30-400 mmol/kg Ca2+ and/or 6-50 mmol/kg Mg2+. Milk type drinks are mentioned. The products may include common food ingredients such as fruits. Example 15 discloses a fermented milk drink including fruitpulp and potassium.

Naismith et al. US published patent application No. US 2005/0124387 discloses a method of decreasing blood pressure in a mammal by administering about 10 mmol/day to about 35 mmol/day of a potassium salt. Also disclosed are supplemented beverages and foodstuffs which provide as a daily serving a supplement of a potassium salt between about 10 mmol/day and about 35 mmol/day. In Example 3, potassium chloride is added to orange juice, potassium bicarbonate is added to orange juice, and potassium citrate is added to orange juice.

Sperti et al. U.S. Pat. No. 3,114,641 discloses an orange juice product intended for dilution which may include potassium salts such as potassium dihydrogen phosphate potassium citrate and potassium acetate.

Wisenberger et al. EP 75 114 is in the German language and is characterized in US 2003/0211204 as disclosing protein-containing fruit juices enriched with vitamins and minerals. The drinks are said to include fruit juice, whey protein concentrate and a mineral salt mixture of potassium, sodium, magnesium, calcium and phosphate.

Medasani et al., U.S. Patent Publication No. 2005/0170020 is directed to a composition of potassium derived from an organic source for treatment of auto-immune diseases and supplementation in the form of general preparation. A food source high in natural or organic potassium content is first dehydrated, such as by freeze drying, reduced to small particles and the carbohydrate content extracted by a solvent. The residue after extraction of carbohydrates is dried and used in pharmaceuticals, food supplements, food products and cosmetics to supplement the body's intake of potassium. In addition to auto-immune disorders such as psoriasis, eczema, multiple sclerosis, etc., other health disorders such as potassium deficiency, hypertension, heart problems, kidney stones and cancer are mentioned.

Medasani et al. mention that a banana contains 400 mg of potassium. Medasani et al. teach use of natural and organic forms of potassium as the best way to supplement potassium but without the high carbohydrates and without stomach gas discomforts. The potassium rich food source which may be used include but is not limited to bananas, avocados, oranges, prunes, apricots, mangoes, raisins, dates, etc. and vegetables like potato, sweet potato, tomato, spinach, and seeds such as lima beans, fried beans, soybeans, sunflower seeds and almonds. When administration of potassium is by trans-dermal patch, forms of potassium other than that obtained from the potassium rich extract may be used, such as inorganic potassium salts, etc. Medasani et al. mention that individuals who do not want to gain weight or who are on low carbohydrate diets do not prefer the high carbohydrate content of dried banana powder.

Wang et al., Canadian Patent Application No. 2559682 is directed to a primary composition containing all essential nutrients of a fruit or a plant material which is said to have increased stability, bioavailability and miscibility. It can be used to supplement a food composition for human consumption such as dairy product, a liquid drink, a milk, a fermented milk product, a yogurt, a milk based powder or an enteral nutrition product. The primary composition can be used for a number of purposes including preventing or treating cardiovascular diseases, or disorders or cancers and stimulating the immune system and reducing blood glucose. In example 3, a yogurt like milk product is provided. The composition may also contain synthetic or natural bioactive ingredients such as amnio acids, fatty acids, vitamins, minerals, carotenoids, polyphenols, etc. The essential bioactive components of fruit, vegetable or plant material may comprise lipids, alkaloids, proteins, carbohydrates, carotenoids, flavones, flavanones, catechins, anthocyanidins, isoflavones, carbohydrates, vitamins, minerals, e.g., selenium, magnesium, potassium.

Ashourian et al., U.S. Patent Application Publication No. 2004/0185161. A milk product containing milk, pectin and a fruit ingredient are disclosed. Major elements said naturally to be present include cations—calcium, sodium, potassium and magnesium in the ingredients or through separate addition to enhance nutritional profile function to stabilize the preferred milk beverage. The cations can be present in a broad range of from about 0.01 to about 2.5% by weight. Di potassium phosphate is mentioned. Among the purees mentioned for inclusion in the product are mango, apple, banana, peach, strawberry, raspberry, blueberry.

Clifford et al. WO 2005/092127 discloses several juices including one or more of potassium sorbate or acesulfame potassium

Yang et al., U.S. Pat. No. 5,648,112 is directed to a process for preparing chilled or shelf stable smooth beverage products which contain milk and a food acid. The process includes mixing the milk with a food stabilizer under high shear mixing conditions and while still maintaining a median particle size of less than 0.8 microns acidifying the mixture to a pH ranging from about 3.2 to about 3.5. The process preferably contains a fruit juice component. Any food grade preservative such as sorbic acid, benzoic acid, alkalimetal salts thereof, preferably sorbic acid, potassium sorbate, and mixtures thereof may be included at levels of from 0.04% to about 0.1%.

Shrikhande et al. US patent application publication No. US 2007/0071871 is directed to a grape extract said to be useful for treating pre-hypertension and Metabolic Syndrome. In Examples 4 and 5, a beverage containing the extract includes potassium sorbate.

Dulebohn et al., U.S. Pat. No. 6,171,633 is directed to a stable composition containing milk, fruit or vegetable juice, gum based stabilizers and a composition containing an amino acid, an organic acid or inorganic acid and a metal ion. Preferred juices include apple, orange, pineapple, cherry, grape, grapefruit, lemon, melon, strawberry, black cherry, lemon-lime, mango, papaya, cranapple, fruit punch, peach, guava, tangerine, apricot, and cranberry juices. A mixed yogurt and fruit emulsion is envisioned. Metal ion sources can include group IA, IIA, Ti, V, Cr, Mn, Co, Ni, Cu and Zn.

Dulebohn et al., U.S. Pat. No. 6,410,077 is directed to a stable mixture of milk, juice and polysaccharide/cereal. In a preferred version of the invention a composition containing an amino acid, an organic or inorganic acid and a, metal ion is added to further stabilize the milk proteins in the mixture. Sucrelesse (U.S. Pat. No. 5,766,636) can be used to stabilize the milk proteins. Sucrelesse is described in the '077 patent as a mixture of amino acids, metal ions (such as group IA, IIA, Ti, V, Cr, Mn, Fe, Co, Ni, Cu, and Zn), organic acids and inorganic acids. Preferred juices include orange, lemon, lime, grape, pear, pineapple, apple, and mixtures thereof.

Rizo et al., U.S. Patent Publication No. 2005/0220964 is directed to a process for producing a low calorie or low fat dairy beverage comprising static inline mixing of yogurt, water and a fruit preparation. The typical fruit base is 30% to 50% fruit, 30% to 50% water, 20% to 25% sugar such as fructose or sucrose, 0% to 10% fruit juice, 1% to 5% of a suitable stabilizer, color, flavor, acid, buffer, e.g., sodium citrate and/or preservative, e.g., potassium sorbate. Juices include but are not limited to juices from preparations conventionally found in yogurt products such as berry juices, strawberries, peaches, or tropical fruits.

Takahashi et al. U.S. Pat. No. 6,833,151 is directed to pectins obtained from extraction from root vegetables and to acidic foods obtained using the pectins. Acidic protein beverages may be obtained by adding citrus or other juices to protein beverages such as milk, acidic milk, and fermented milk. Animal or vegetable proteins can include skim milk, whole milk, skim milk powder, processed milk obtained by fortification with minerals such as calcium or vitamins, fermented milk and proteins obtained from same. Takahashi et al. U.S. Pat. No. 6,632,469 is similar.

Nguyen et al. US 2006/0057247 discloses a process for producing a low carbohydrate fermented dairy product including a fruit preparation. The typical fruit base is 30-50% fruit, 30-50% water, 20-25% sugar; 0-10% fruit juice, 1-5% stabilizer, flavor, acid, buffer, eg sodium citrate, and/or preservative, eg, potassium sorbate. Fruit juices may be juices from fruit preparations conventionally found in yogurt. Mineral content such as potassium, sodium or calcium may be supplemented.

Thorsoe et al. US published patent application 2006/0210668 is directed to a process for producing a food product comprising contacting the food product with a stabilizer to form an intermediate and fermenting the intermediate wherein the stabilizer comprises a depolymerized pectin and wherein the food product comprises a protein. The patent mentions that pectin has traditionally been used as a stabilizer in protein-containing food products such as acidified protein beverages and stirred yoghurt. Preferably a fruit juice is included. Suitable products include cheese, quarg, sour cream, fermented dessert products, and liquid yoghurt such as drinking yoghurt.

Takahashi U.S. Pat. No. 6,890,578 is directed to acidic protein foods employing pectin which has been low molecularized as a stabilizer. Fruit juice and acidic milk beverages may be used.

Bernardini et al. US 2004/0265464 is directed to a tri-gum blend of xanthan gum, gellan gum and pectin gum used to provide mouthfeel and stability to beverages, preferably smoothie beverages.

Brain et al. U.S. Pat. No. 5,503,863 discloses a fruit juice and a vegetable juice in Examples XI and XII which may include as additional ingredients disodium phosphate buffering agent and preservatives such as potassium sorbate. Brain et al. U.S. Pat. No. 5,451,420 is similar.

Takagaki et al. US Patent application Publication No. US 2005/0158409 is directed to compositions containing proanthocyanidins as active components. Example 26 is a soft drink including pine bark extract and 280 mg per L of potassium chloride.

Draijer EP 1607006 is directed to a food composition comprising elderberry and/or blackcurrant having a polyphenol content of 300 mg/kg or more. Product types include fruit juice products and dairy type products. Minerals are mentioned as potential ingredients in the dairy type products.

Draijer et al. WO 2005/122793 is directed to a food composition comprising wine extract, grape juice extract and preferably berry extract. Yogurt type products having casein solids, whey powder, sugar, yoghurt culture, fruit, vitamins, minerals and stabilizer are mentioned.

Beutler et al. U.S. Pat. No. 5,972,393 discloses a dehydrated, acidified milk product. Potassium caseinate may be used as a starting material.

Bastian et al. US patent application publication no. 2003/0118662 discloses food products fortified with a therapeutically effective amount of milk mineral administered for treatment of high blood pressure, stroke, obesity, kidney stones and numerous other diseases. Natural milk minerals mentioned include calcium, magnesium, phosphorus, potassium and zinc. Milk mineral can be incorporated into a wide variety of types of food products such as dairy products and acidic juice beverages like orange juice and grapefruit juice. Example 5 discloses a milk mineral-fortified orange juice. Example 6 illustrates a yogurt drink.

Tropicana—Healthy Heart product claim: potassium helps reduce the risk of high blood pressure. According to the package it contains 450 mg potassium, 22 g of sugar and 110 kcal per 8 fl. Oz serving.

Kellogg's® Smart Start® is a breakfast cereal said to contain high potassium and low sodium. It is believed to be fortified with potassium chloride. The package indicates that it contains for a 60 g serving 230 kcal, 17 g of sugar and 380 mg of potassium.

Quaker Oatmeal—Take Heart® is said to reduce the risk of high blood pressure. It is believed to be fortified with potassium gluconate. According to the label, a 45 g serving has 160 kcal, 9 g of sugar and 350 mg of potassium.

100 g of fresh orange juice provides 200 mg of potassium and 45 kcal according to the USDA.

100 g of banana contains 358 mg of potassium and 89 kcal.

### SUMMARY OF THE INVENTION

The present invention is directed to a solution for the problem of maximizing potassium intake while minimizing the caloric intake. The invention relates to a food product, preferably a beverage, suitable for ingestion by humans and having at least 300, preferably at least 320, most preferably at least 350 mg of potassium ion per 100 g serving. The potassium is from both one or more inorganic sources comprising at least 25 mg potassium ion per 100 g serving of the food product and one or more organic sources. Preferably the potassium from the inorganic source includes at least 35 mg potassium ion per 100 g serving of the food product of the invention. A preferred product includes up to 1500 mg of potassium ion per 100 g serving of food product, especially up to 1000 mg potassium ion per 100 g serving. The food product has no fewer than 25 kcals and has fewer than 75 kcal per 100 g serving.

By combining the high potassium levels with minimal calories, the food of the invention permits enjoyment of the benefits of high potassium in a food without the negative of high caloric intake. Indeed, by using an organic source such as fruit partially as the potassium source, we are able to increase potassium intake nutritionally, e.g., while also including other natural vitamins and minerals such as vitamin C, while minimizing caloric impact and avoiding bitter taste.

In a preferred embodiment, the food of the invention includes at least 400 mg of potassium ion per 100 g serving.

By organic sources is meant that the potassium ingredient is derived from an organism such as an animal, vegetable or algae. Examples of organic sources of potassium ions include fruits, vegetables and cow's milk. Inorganic sources are not derived from an organism and are often mined from the earth. The mere fact that a potassium salt includes carbon atoms, e.g., potassium gluconate, does not make that a potassium salt from an organic source if the source is not as indicated above. If desired, the potassium salt may be purified, isolated, concentrated, contained in particular fractions or modified and it will still be considered as from an organic source. One advantage to using an organic source is that the potassium will bring with it other beneficial components, albeit in small amounts if the level of purification is high. In this respect, it is preferred that the organic source potassium include at least 0.001 wt % in impurities (i.e., components other than the potassium salt) derived from the organic source.

Preferably, the organic source provides from 20-80 wt % of the potassium ion in the food and the inorganic source provides from 80 to 20 wt % of the potassium ion in the food. The wt/wt ratio of the potassium originating from an organic source to inorganic source is preferably 35:70 to 70:35, especially 40:60 to 60:40, particularly around 40:60.

Preferred organic and inorganic sources for the potassium ions are, respectively, fruit, especially fruit juices, purees and/or concentrates (organic source) and dairy ingredients, such as yogurt powder, and potassium phosphate salts derived from inorganic sources.

Especially preferred are use of at least two fruits with or without dairy/yogurt powder as organic sources of potassium ions.

In accordance with a preferred embodiment, the food product comprises 5-25 degrees brix. Brix is a measure of the soluble solids. More preferably, the food product is from 10-20 degrees brix. The percentage of solids in the product is preferably 5-25, especially 10-20 wt %.

The food product of the invention further preferably includes at least 0.2 grams, preferably 0.25 grams, soluble fiber per 100 g serving. Ideally, the food comprises no more than 1 gram of soluble fiber per 100 g serving. The product preferably includes at least 0.2, preferably 0.25 grams, of insoluble fiber per 100 g serving and not more than 1 gram of insoluble fiber per 100 g serving.

The food product of the invention can come in many forms, but is most preferably a beverage containing milk solids such as a yogurt drink. In such case, the milk solids may be present in the form of a yogurt powder which is reconstituted with water. Active strains may or may not be present in the beverage. Where possible, it is preferred that the food of the invention be free of chemical preservatives. The dairy component will add to the organic potassium level. Especially preferred is a yogurt beverage including fruit juice as well.

Since sodium may, for some people, negate or offset the blood pressure maintenance benefits of potassium intake, it is preferred to minimize the level of sodium ions in the products of the invention. Therefore, preferred sodium ion levels are not in excess of 90 mg, preferably up to 50 mg, most preferred up to 25 mg, per 100 g serving of the product.

The food product of the invention is preferably a beverage having a viscosity at 22° C., say of from 40-750 cps, preferably from 50 to 650 cps as measured on a Haake viscometer having using the procedure set forth below in the detailed description.

For a more complete understanding of the above and other features and advantages of the invention, reference should be made to the following description of the preferred embodiments.

### DETAILED DESCRIPTION OF THE INVENTION

The food product of the invention can take many forms, such as, yogurt drink, soy drink, frozen confection, tea-based, dairy based, fruit based, vegetable based, and/or protein based beverages and combinations thereof.

A particularly preferred product is a fruit-containing drink wherein the fruit or fruits are the main organic source of potassium ion. Suitable fruits include bananas, avocados, oranges, prunes, apricots, mangoes, raisins, dates, apple, orange, pineapple, cherry, grape, grapefruit, lemon, melon, strawberry, black cherry, lemon-lime, mango, papaya, cranapple, fruit punch, peach, guava, tangerine, apricot, cranberry, pomegranate and passion fruit. A particularly favorable form for inclusion of the fruit is as a puree. Vegetables may also be included, with or without the fruit. Suitable vegetables include potato, sweet potato, tomato, spinach, carrots and pumpkin and seeds such as lima beans, fried beans, soybeans, sunflower seeds and almonds. The fruit or vegetable is preferably used at a level to provide 5-25 degrees brix. More preferably, the fruit and/or vegetable provided at a level such that the product has 10-20 degrees brix. The percentage of solids in the product is preferably 5-25, especially 10-20 wt %

Because one of the types of sources of potassium is organic, the possibility exists to enhance the nutritional value of the product in other respects, e.g., with respect to other minerals and vitamins. For example, the Vitamin C level in the product of the invention is preferably at least 10%, especially at least 15% of the DV per 100 mg serving of the beverage, especially from 15-20%. The DV for Vitamin C shall, for the purposes of this application, be assumed to be 60 mg.

Potassium compounds which may be obtained from inorganic sources of potassium ions include potassium phosphate compounds such as dipotassium phosphate. Others include potassium gluconate, potassium citrate, potassium bicarbonate, potassium oxide, potassium iodide, potassium tartrate, potassium lactate, potassium carbonate, potassium chloride, potassium hydroxide, potassium sulfate and potassium glutarate,

Yogurt powder is a preferred milk solid for inclusion in a beverage or other food of the invention. Suitable yogurt powder is available from Kerry of Beloit, Wisconsin. Other forms of milk solid which can be advantageously employed in the compositions include skim milk powder, and whole milk powder, whey protein isolate, non-fat dried milk, skim milk, whole milk, 1% fat milk and 2% fat milk. Additional protein sources include one or more other dairy protein sources, such as buttermilk, condensed milk, evaporated milk, milk solids non-fat, etc. The dairy source may contribute dairy fat and/or non-fat milk solids such as lactose and milk proteins, e.g. the whey proteins and caseins. Where desired to minimize the caloric impact, protein may be added as such rather than as one component of a food ingredient such as whole milk. Preferred in this respect are protein concentrates such as one or more of whey protein concentrate as mentioned above, milk protein concentrate, caseinates such as sodium and/or calcium caseinate and/or potassium caseinate, isolated soy protein and soy protein concentrate. The milk ingredient is preferably used at a level of from 0 to 4.0%, preferably from 1.0% to 2.0% for powder or concentrate, and at levels of from 0 to 40%, especially 1 to 35%, most preferably from 10 to 20% by weight as liquids.

Water will generally be included in the food of the invention at a level of from 50% to 90%, especially from 60% to 80%.

At least where the food of the invention takes the form of a beverage, it will typically include one or more stabilizers, thickening agents and/or emulsifiers. A preferred stabilizer is pectin such as pectin AMD available from Danisco of Elmsford, N.Y. Preferred pectins herein are highly esterified. In beverages of the invention, pectin is preferably used at levels of from 0 to 0.3%, especially from 0.1 to 2 wt %. Other stabilizers, emulsifiers, and/or thickening agents may also be used in the beverages and other foods of the invention, especially gelatin, leguminous seeds or seed extracts containing galactomanens or the like, carob gum, gum Arabic gum ghatti, guar gum, locust bean gum, carrageenan, furcellaran, alginate, amylopectin, amlylose, other starches such as rice, corn and/or potato starches, cellulose and cellulose derivatives including sodium carboxymethyl cellulose and xanthan gum. These may be present at levels of 0 to 0.2%, especially from 0.05 to 1.5 wt %.

The foods of the invention may optionally include sources of unsaturated fatty acids, although it may be desirable to minimize or eliminate fats and oils to decrease the caloric impact of the product. Among these may be included vegetable oils, marine oils such as fish oils and fish liver oils and algae. Possible vegetable oil sources include olive oil, soybean oil, canola oil, high oleic sunflower seed oil, high oleic safflower oil, safflower oil, sunflower seed oil, flaxseed (linseed) oil, corn oil, cottonseed oil, peanut oil, evening primrose oil, borage oil, and blackcurrant oil.

If desired, the foods of the invention may include sources of omega-3 and/or omega-6 fatty acids, some of which are mentioned above. Among those which may be useful are included arachidonic acid, docosahexaenoic acid (DHA), eicosapentaenoic acid (EPA), lineoleic acid, linolenic acid (alpha linolenic acid) and gamma-linolenic acid.

The food of the invention may include various other oils or fats. In addition to those mentioned above, such oils and fats include other vegetable fat, such as for example, cocoa butter, illipe, shea, palm, palm kernal, sal, soybean, safflower, cottonseed, coconut, rapeseed, canola, corn and sunflower oils, or mixtures thereof. A blend of oils (e.g., canola, soybean, or high oleic oils) may be used, especially containing either synthetic antioxidants such as BHT, TBHQ or natural antioxidants such as mixed tocopherols, ascorbic acid and rosemary extract or a blend of the above. When the source is for linoleic and linolenic acids (C18:2 and C18:3), straight oil or blends of oil such as canola plus soybean with an appropriate antioxidant system can be used. However, animal fats such as butter fat may also be used if consistent with the desired nutritional profile of the product.

Where PUFA-containing fats are used, added antioxidants such as tocopherols, ascorbic acid and/or rosemary extract may be employed.

The preferred product is a beverage. However, if the food product is to be in a gelled form, or if desired to provide extra viscosity, a gelling biopolymer may be employed. The amount of gelling biopolymer, if any, in compositions of the invention is dependant on the desired degree of gelling and the presence of other ingredients in the composition. Usually the amount of gelling agent, if used, lies between 0 and 36%, mostly between 0.1 and 25% based on the weight of the aqueous phase of the product. If hydrolyzed starches are present their level is preferably from 5-20%; other gelling agents are generally used at levels of up to 10%, mostly 1-7%, most preferred 2-5%, all percentages being based on the weight of the aqueous phase. Particularly preferred are combinations of, say, 5-15% hydrolyzed starch and 0.5-5% of other gelling materials. Preferably the other gelling material includes gelatin.

Carbohydrates can be used in the food of the invention at levels of from 1 to 10%, especially from 2 to 5%. Typically, the food of the invention will be naturally sweetened, at least in part. Natural sources of sweetness include sucrose (liquid or solids), glucose, fructose, and corn syrup (liquid or solids), including high fructose corn syrup, corn syrup, maltitol corn syrup, high maltose corn syrup and mixtures thereof. Other sweeteners include lactose, maltose, glycerine, brown sugar and galactose and mixtures thereof. Polyol sweeteners other than sugars include the sugar alcohols such as maltitol, xylitol and erythritol. In accordance with the invention, it will generally be desirable to eliminate or minimize carbohydrates to minimize the caloric impact of the product.

If it is desired to use artificial sweeteners, Any of the artificial sweeteners well known in the art may be used, such as aspartame, saccharine, Alitame® (obtainable from Pfizer), acesulfame K (obtainable from Nutrinova), cyclamates, neotame, sucralose, mixtures thereof and the like. The artificial sweeteners are used in varying amounts of about 0% to 0.25 wt. % on the food, preferably 0.001% to 0.05% depending on the sweetener, for example. Aspartame may be used at a level of 0% to 0.25%, preferably at a level of 0.001% to 0.05%. Acesulfame K is preferred at a level of 0.001% to 0.25%. Sucralose may be used at a level of from 0.001 to 0.25% especially from 0.001 to 0.05%.

In addition to sweeteners, the fibers and the carbohydrate bulking agents mentioned below, examples of suitable carbohydrates include starches such as are contained in rice flour, flour, peanut flour, tapioca flour, tapioca starch, and whole wheat flour and mixtures thereof.

Organic acids may be employed at from 0 to 0.25 wt %, especially 0.01 to 0.25 wt %. Suitable acids include lactic acid, malic acid, citric acid and tartaric acids Where desired, inorganic acids may also be used, especially hydrochloric acid, acetic acid, and/or phosphoric acid at from 0 to 0.25 wt %, especially 0.01 to 0.25 wt %. Flavors and colorants may be added, as desired, at from 0.01 to 0.25% for flavors and 0.001 to 0.25% for colorants.

The beverage according to the invention is made by mixing the ingredients under agitation and heat, pasteurizing, cooling and homogenizing. Product is filled at elevated temperature and then cooled.

### EXAMPLE 1

### Prophetic

The preparation of a fruit-based beverage using the following ingredients:

| Ingredient | Level (%) |
|---|---|
| Water | 67.01 |
| Fruit Puree | 28.00 |
| Yogurt Powder | 1.50 |
| *Sweetner (Sugar and Sucralose) | 2.52 |
| Dipotassium Phosphate | 0.46 |
| Pectin | 0.20 |
| Flavor | 0.08 |
| Organic Acid | 0.13 |
| Color | 0.01 |
| Gum | 0.1 |

*2.5% sucrose
*0.02% sucralose liquid (25% solids in the liquid)

Process: ingredients are mixed at 155° F. under intense agitation. The mixture is then pasteurized at 220° F., cooled to 185° F. and homogenized at 2500 psi. Product is filled at 192° F. and cooled immediately afterwards.

The pH of the product is 3.9. It has 50 kcal and 350 mg of potassium/100 ml

### EXAMPLE 2

### Prophetic

The preparation of a fruit-based beverage using the following ingredients:

| Ingredient | Level (%) |
|---|---|
| Water | 72.01 |
| Fruit Puree | 22.50 |
| Yogurt Powder | 1.50 |
| *Sweetner (Sugar and Sucralose) | 3.03 |
| Dipotassium Phosphate | 0.50 |
| Flavor | 0.25 |
| Pectin | 0.20 |
| Color | 0.02 |
| Gum | 0.1 |

*3% sucrose
*0.03% sucralose liquid (25% solids in the liquid)

Process: ingredients are mixed at 155° F. under intense agitation, the mixture is then pasteurized at 220° F., cooled to 185° F. and homogenized at 2500 psi. Product is filled at 192° F. and cooled immediately afterwards.

Product pH=3.9. The product is 40 kcal and 350 mg of potassium/100 ml.

It will be appreciated that when fatty acids are mentioned herein, generally these will be present in the form of glycerides such as mono-, di- and triglycerides. Therefore, “fatty acids” encompasses glycerides containing them.

Unless stated otherwise or required by context, the terms “fat” and “oil” are used interchangeably herein. Unless otherwise stated or required by context, percentages are by weight.

The word “comprising” is used herein as “including, but not limited to” the specified ingredients. The words “including” and “having” are used synonymously.

### Rheological Protocol for Testing Drinks

A Haake Rheological Instrument Mars model may be used. The liquid samples are tested on a coaxial cylinder (B505, Z20DIN) with an inner cylinder diameter of 20 mm and an outer cylinder diameter of 21.60 mm with a gap of 0.8 mm using a controlled temperature bath at 22° C.

Method: Viscosity is obtained by ramping up the shear rate, and its values are reported at 10 s⁻¹ at 22° C. The values are determined based on rigorous rheological principles using Haake provided software.

Brix: brix is measurement of total soluble solids, commonly used to measure the amount of sucrose in fruits. Measurement is by a refractometer such as a Bellingham and Stanley Ltd RFM 320 Refractometer, calibrated against distilled water.

### Determination of Brix Content of Liquid Samples

This method determines the dissolved solids content of a sample by direct measurement using a temperature controlled refractometer. The method is applicable to all liquid samples which do not contain suspended solids.

The equipment used is a Bausch and Lomb “Abbe” Refractometer, or equivalent, equipped with R.I. and Brix scale as well as jacketed prisms for constant temperature control, a Water bath, Masterline Model 2095, combination bath and circulator, refrigerated, −20° C. to 70° C. and a plastic rod or small plastic pipet.

The procedure is as follows. Turn on the water bath and set the temperature control to the required temperature (20° C. unless specified otherwise). Wait until thermometer on refractometer is steady at the required temperature +,−0.5° C. before taking any readings. Open the double prism and using plastic rod or small pipet, place two or three drops of sample on the prism, taking care not to touch it with the rod. A plastic rod is preferable to prevent prism damage if touched. Close prism and allow a few seconds for the sample to reach temperature equilibrium. Turn on the light and position it to provide optimum lighting when looking through the microscope eyepiece. Rotate the alidade (large knob) until the field of vision is divided into light and dark portions. Rotate the screw head of the compensator (small center knob) until a sharp, colorless line is obtained dividing the light and dark regions. Adjust the dividing line until it falls on the point of intersection of the cross hairs. Press button to reveal scale (Brix scale should be selected ) and read brix directly. Perform three readings and take the average as the brix result. Carefully wipe prisms with water moistened lens tissue. Dry and close the prism, leaving a clean dry tissue between the surfaces.

% total solids: total solids content is a measure of the amount of material remaining (lipids/fat, protein, carbohydrates, minerals) after all the water has been evaporated=100−% moisture.

To obtain an accurate measurement of the moisture content or total solids of a food using evaporation methods it is necessary to remove all of the water molecules. Vacuum oven method: Weighed samples are placed under reduced pressure (typically 25-100 mm Hg) in a vacuum oven for a specified time and temperature and their dried mass is determined. A suitable time and temperature is 10 hrs at 70C.

It should be understood of course that the specific forms of the invention herein illustrated and described are intended to be representative only, as certain changes may be made therein without departing from the clear teachings of the disclosure. Accordingly, reference should be made to the appended claims in determining the full scope.

What is claimed is:

1. A beverage suitable for ingestion by humans having at least 300 mg of potassium ion per 100 g serving, said potassium being from both one or more inorganic sources which provide a potassium level of at least 25 mg for the beverage and one organic source, the beverage having no fewer than 25 kcals and having no greater than 75 kcal per 100 g serving.

2. The beverage according to claim 1 wherein the organic source provides from 20-80 wt % of the potassium ion and the inorganic source provides from 80 to 20 wt % of the potassium ion, based on the weight of the beverage.

3. The beverage according to claim 1 wherein the organic source is a fruit.

4. The beverage according to claim 1 wherein the organic source are fruit and dairy.

5. The beverage according to claim 1 wherein the inorganic source is a potassium phosphate.

6. The beverage according to claim 1 comprising 5-20 brix, fruit solids.

7. The beverage according to claim 1 wherein the organic source of potassium comprises at least two fruits.

8. The beverage according to claim 1 further comprising at least 0.2 grams soluble fiber per 100 g serving.

9. The beverage according to claim 8 comprising no greater than 1 gram of soluble fiber per 100 g serving.

10. The beverage according to claim 1 having a Vit C level of at least 10% DV.

11. The beverage according to claim 1 having a organic Vit C level of at least 15% DV.

12. The product according to claim 1 wherein the ratio of organic source to inorganic source is 35:70 to 70:35.

13. The product according to claim 1 wherein the ratio of organic source to inorganic source is 40:60 to 60:40.

14. The product according to claim 1 wherein the weight ratio of organic source to inorganic source is 40:60.

15. The beverage according to claim 1 wherein the beverage includes no chemical preservatives.

16. The beverage according to claim 1 comprising milk solids.

17. The beverage according to claim 16 wherein said milk solids include yogurt powder.

18. The beverage according to claim 1 comprising up to 1500 mg potassium ions per 100 g of product.

19. The beverage according to claim 1 comprising up to 1000 mg potassium ions per 100 g of product.

20. The beverage according to claim 1 wherein the inorganic source provides at least 35 mg potassium per 100 g of said product.

21. The beverage according to claim 10 wherein the Vitamin C in the beverage is provided by an organic source.

22. The beverage according to claim 11 wherein the Vitamin C in the beverage is provided by an organic source.
